(19) United States
(12) Patent Application Publication
(10) Pub. No.: US 2026/0188920 A1
(43) Pub. Date: Jul. 2, 2026

(54) TERMINAL BLOCK

(71) Applicant: Yazaki Corporation, Tokyo (JP)

(72) Inventors: Daisuke YAMANASHI, Shizuoka (JP); Jumpei HAYASHI, Shizuoka (JP)

(73) Assignee: Yazaki Corporation, Tokyo (JP)

(21) Appl. No.: 19/421,088

(22) Filed: Dec. 16, 2025

(30) Foreign Application Priority Data
Dec. 26, 2024 (JP) 2024-230135

(51) Int. Cl. H01R 9/24

(52) U.S. Cl. CPC H01R 9/24

(57) ABSTRACT

A terminal block includes a bus bar that extends in an axial direction and is connected to an external terminal, and a housing that holds the bus bar. The bus bar has an inner portion provided inside the housing, a cooling flow path through which a cooling oil as a cooling medium flows is provided inside the housing, and the inner portion of the bus bar is provided in the cooling flow path.

### CROSS-REFERENCE TO RELATED APPLICATION(S)

The present application claims priority to and incorporates by reference the entire contents of Japanese Patent Application No. 2024-230135 filed in Japan on December 26, 2024.

### BACKGROUND OF THE INVENTION

### 1. Field of Invention

The present invention relates to a terminal block.

### 2. Description of the Related Art

As a technique related to a terminal block in the related art, for example, JP 2023 - 162 655 A discloses a terminal block including a plurality of connection portions to which bus bars including terminals are respectively connected, a storage portion that stores injected coolant, and a partition portion that partitions between the storage portion and the plurality of connection portions, in which the partition portion is provided with a plurality of flow paths through which the coolant flows from the storage portion into the plurality of connection portions, respectively.

By the way, such a terminal block cools a bus bar exposed in the connection portion by, for example, coolant as a cooling medium passing through a flow path from a storage portion of the terminal block. However, there is room for further improvement in a configuration for cooling the bus bar connected to and held by the terminal block by the cooling medium.

### SUMMARY OF THE INVENTION

The present invention has been made in view of the above circumstances, and an object thereof is to provide a terminal block capable of appropriately cooling a bus bar held by the terminal block.

In order to achieve the above mentioned object, a terminal block according to one aspect of the present invention includes a bus bar that extends in an axial direction and is connected to an external terminal; and a housing that holds the bus bar, wherein the bus bar has an inner portion provided inside the housing, a cooling flow path through which a cooling medium flows is provided inside the housing, and the inner portion of the bus bar is provided in the cooling flow path.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a terminal block according to an embodiment;

FIG. 2 is an exploded perspective view illustrating the terminal block according to the embodiment;

FIG. 3 is a cross-sectional view taken along line III-III of FIG. 1;

FIG. 4 is a cross-sectional view taken along line IV-IV of FIG. 3;

FIG. 5 is a partially enlarged perspective view illustrating a periphery of an inlet according to the embodiment and illustrating an attachment target in cross section; and

FIG. 6 is a partially enlarged perspective view illustrating a periphery of an outlet according to the embodiment and illustrating an attachment target in cross section.

### DETAILED DESCRIPTION OF THE PREFERRED EMBODIMENTS

Hereinafter, an embodiment according to the present invention is described in detail with reference to the drawings. Note that the present invention is not limited by the embodiment. In addition, components in the following embodiments include those that can be replaced and are easily replaced by those skilled in the art or those that are substantially the same.

### Embodiment

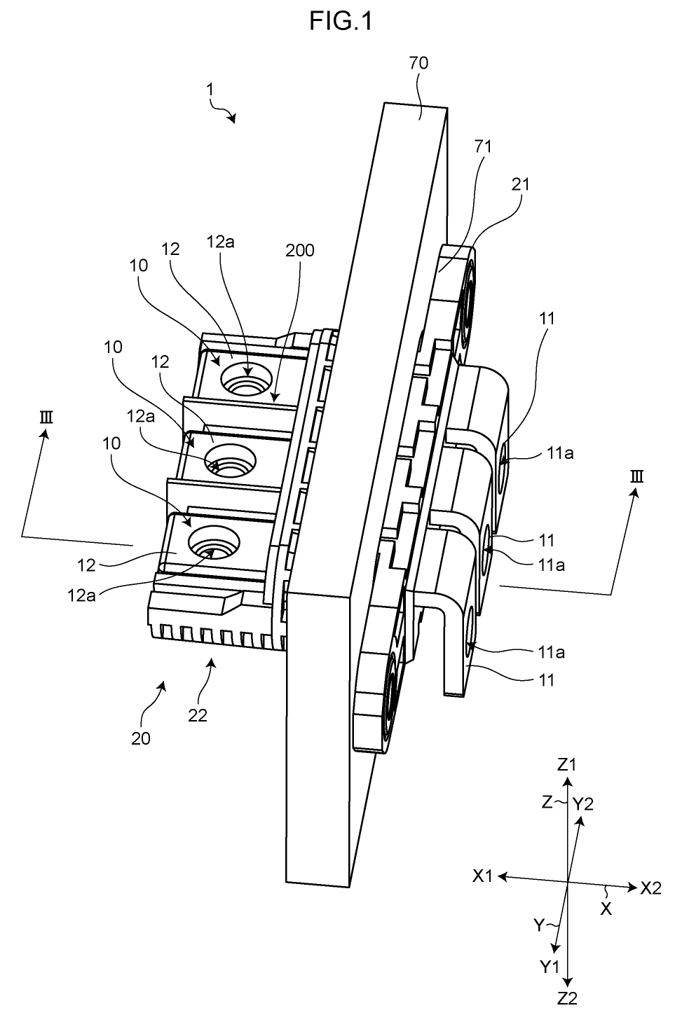

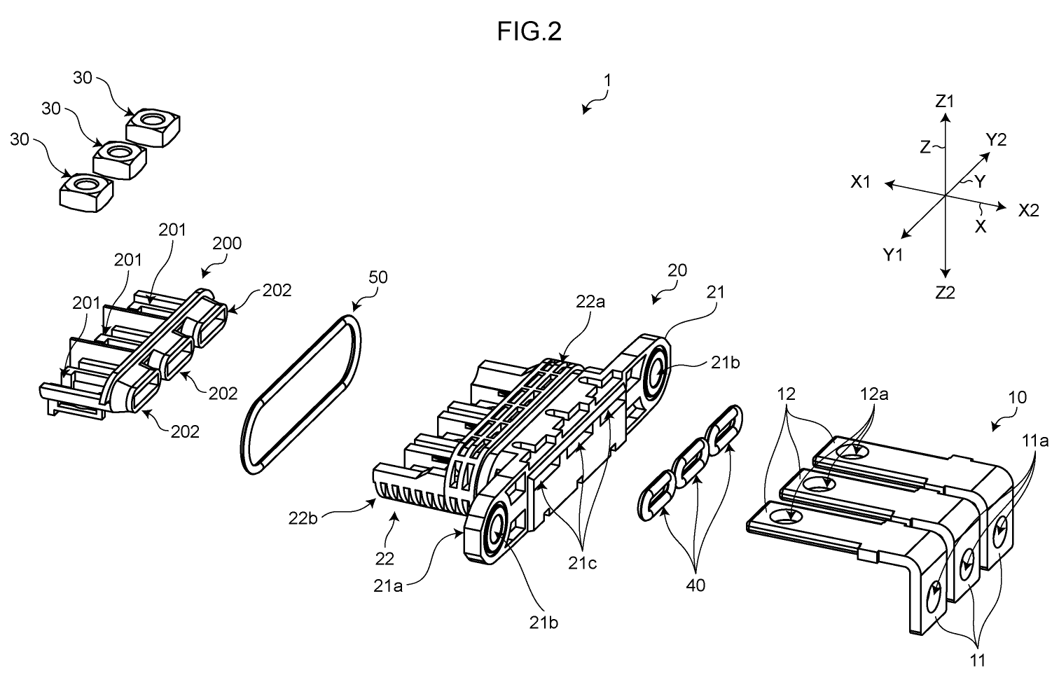

A terminal block 1 of the present embodiment illustrated in FIGS. 1 and 2 is mounted, for example, on a vehicle such as an electric car or a hybrid car, is attached to an attachment target 70, and relays electrical connection between a first device and a second device (not illustrated). The terminal block 1 of the present embodiment includes a plurality of (three) bus bars 10, and the external terminal of the first device is electrically connected to a first connection portion 11 provided at one end portion of the plurality of bus bars 10. Also, in the terminal block 1 of the present embodiment, the external terminal of the second device is electrically connected to a second connection portion 12 provided in the other end portion of the plurality of bus bars 10. The first device is, for example, one of a motor and an inverter, and the second device is, for example, the other of the motor and the inverter. Note that the terminal block 1 is not limited to this example and may be used for, for example, relaying between the first device or the second device and the wiring material or relaying between the wiring materials.

Note that in the following description, a direction in which the bus bars 10 extend is defined as an axial direction X, a direction which is orthogonal to the axial direction X and in which the plurality of bus bars 10 are arranged is defined as a width direction Y, and a direction orthogonal to the axial direction X and the width direction Y is defined as a height direction Z. Further, one side in the axial direction X is defined as one side X1, and the other side is defined as the other side X2. Similarly, one side Y1 and the other side Y2 are set in the width direction Y, and one side Z1 and the other side Z2 are set in the height direction Z.

The terminal block 1 includes the plurality of bus bars 10 and a housing 20 that holds the plurality of bus bars 10. The housing 20 includes a front holder 200 that holds a plurality of nuts 30. Each of the bus bars 10 includes the first connection portion 11 and a second connection portion 12 formed by being bent at a right angle from the first connection portion 11, and each portion is three-dimensionally integrally formed in a substantially L shape by performing various types of processing such as bending processing on a metal material such as a sheet metal material according to a shape corresponding to each portion. The first connection portion 11 is formed in a plate shape extending in the height direction Z and having a plate surface facing the axial direction X. The second connection portion 12 is formed in a plate shape extending in the axial direction X and having a plate surface facing the height direction Z. A connection hole 11a penetrating in the axial direction X is provided on the other side Z2 of the first connection portion 11 in the height direction Z. Similarly, a connection hole 12a penetrating in the height direction Z is provided on one side X1 of the second connection portion 12 in the axial direction X. The external terminal of the first device is connected to the connection hole 11a of the first connection portion 11, and the external terminal of the second device is connected to the connection hole 12a of the second connection portion 12.

The housing 20 includes a housing body 21 and a bus bar holding portion 22 and is integrally formed of an insulating synthetic resin material or the like. The housing body 21 is formed in a substantially long rectangular plate shape with the width direction Y as a longitudinal direction. A surface of the housing body 21 on one side X1 in the axial direction X is a substantially flat attachment surface 21a that abuts on a surface of the attachment target 70 on the other side X2 in the axial direction X. Attachment holes 21b are provided in the vicinity of end portions on one side Y1 and the other side Y2 of the housing body 21 in the width direction Y. The attachment hole 21b is a hole penetrating in the axial direction X, and a bolt (not illustrated) is inserted into the attachment hole to fix the terminal block 1 to the attachment target 70 via the attachment hole 21b.

The bus bar holding portion 22 of the housing 20 is provided at a substantially central portion of the housing body 21 in the width direction Y. The bus bar holding portion 22 is formed so as to protrude from the attachment surface 21a of the housing body 21 toward the one side X1 in the axial direction X. The bus bar holding portion 22 holds the plurality of bus bars 10 extending in the axial direction X so as to cross the attachment surface 21a. A base portion 22a of the bus bar holding portion 22 on the housing body 21 side is formed in a substantially columnar shape in which a cross section having a substantially rounded long rectangular shape in the width direction Y as a longitudinal direction extends in the axial direction X. The other side X2 of the base portion 22a in the axial direction X is connected to the housing body 21.

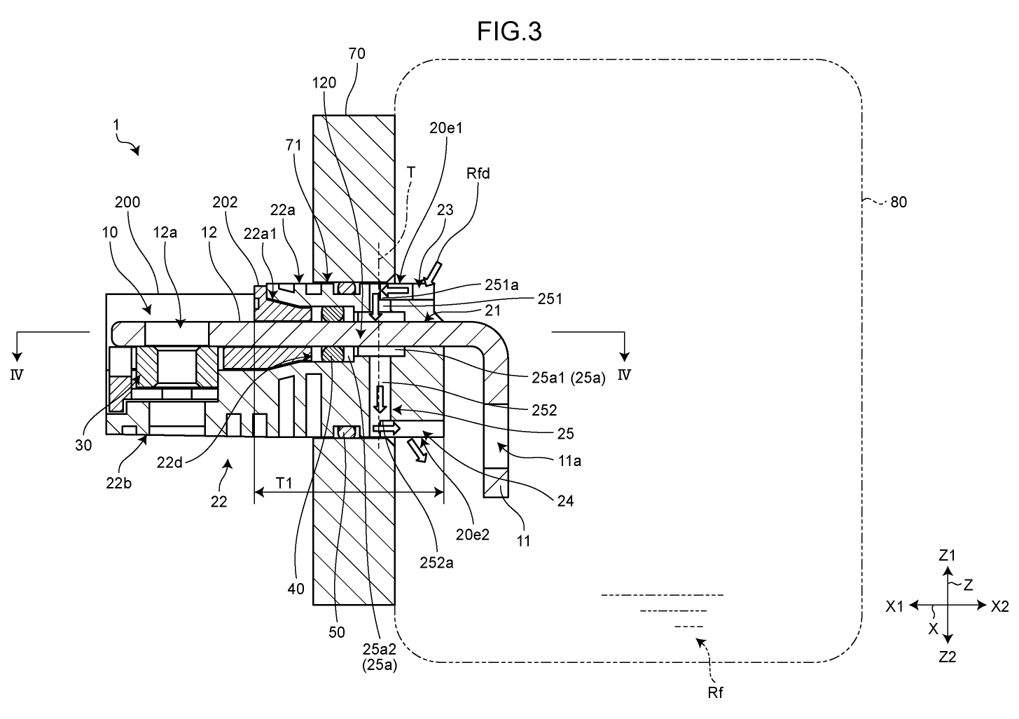

Each of the bus bars 10 is fixed and held to the housing 20 by insert molding. Specifically, an outer surface of a part of the other side X2 in the axial direction X of the second connection portion 12 of each bus bar 10 is in close contact with the housing 20 in a holding portion 21c of the housing 20 (see also FIG. 3). In this manner, each of the bus bars 10 is held by the housing 20.

The base portion 22a of the housing 20 is provided with a seal member 50 assembled to an annular groove portion. The housing 20 is attached in a state where the bus bar holding portion 22 is inserted into an attachment hole 71 penetrating the attachment target 70, and the base portion 22a is positioned in the attachment hole 71. At this time, the inner peripheral surface of the attachment hole 71 of the attachment target 70 and the outer periphery of the base portion 22a of the housing 20 are sealed with the annular seal member 50. Here, the attachment target 70 is a part of an oil tank 80 (see FIG. 3). The oil tank 80 stores, for example, a cooling oil Rf as a cooling medium for cooling a motor (not illustrated). Therefore, a part of the other side X2 in the axial direction X of the terminal block 1 which includes the first connection portion 11 of the bus bar 10 is exposed to the inside of the oil tank 80.

The bus bar holding portion 22 of the housing 20 is provided with a distal end portion 22b having a substantially flat plate shape on the one side X1 of the base portion 22a in the axial direction X. The front holder 200 is provided in the distal end portion 22b. The front holder 200 includes a plurality of nut holding portions 201 that hold the plurality of (three) nuts 30, which are square angular nuts, and an insertion portion 202 provided on the other side X2 in the axial direction X of each nut holding portion 201. The insertion portion 202 is formed in a substantially flat tubular shape having an outer periphery formed in a substantially tapered shape and is inserted into the base portion 22a of the bus bar holding portion 22.

More specifically, as illustrated in FIG. 3, the one side X1 in the axial direction X of the holding portion 21c of the housing 20 is set as a space portion in which an end portion on the one side X1 is an inserted opening 22a1, and the second connection portion 12 of the bus bar 10 is disposed in the space portion. Note that the space portion includes a bus bar cooling chamber 25a and a gasket accommodating portion 22d described below. Also, the insertion portion 202 of the front holder 200 is inserted into the inserted opening 22a1. The second connection portion 12 of the bus bar 10 is inserted into the insertion portion 202 of the front holder 200, is exposed from the insertion portion 202, and is disposed so that the connection hole 12a of the second connection portion 12 and the screw portion of the nut 30 are concentric on one side Z1 in the height direction Z of the nut 30 held by the nut holding portion 201.

Here, in the second connection portion 12 of the bus bar 10, a part of a region T1 along the axial direction X from the end portion of the other side X2 in the axial direction X of the holding portion 21c to the end portion of the one side X1 in the axial direction X of the insertion portion 202 of the front holder 200 where the second connection portion 12 of the bus bar 10 is exposed is set as an inner portion 120. In other words, the bus bar 10 includes the inner portion 120 provided inside the housing 20.

The inserted opening 22a1 into which the insertion portion 202 of the front holder 200 is inserted communicates with the gasket accommodating portion 22d. The gasket accommodating portion 22d is provided with a gasket 40 disposed around the axial direction X of the second connection portion 12 of the bus bar 10. The gasket 40 is also referred to as a terminal gasket, a rubber plug, a bush, or the like. The gasket 40 is formed in a substantially flat annular shape (see also FIG. 2) and is in close contact with the outer surface of the second connection portion 12 of the bus bar 10 and the inner surface of the gasket accommodating portion 22d. Accordingly, the gasket 40 seals between the bus bar 10 (the inner portion 120) and the housing 20 with respect to a cooling flow path 25 described below. That is, the gasket 40 seals between the bus bar 10 (the inner portion 120) and the housing 20 (the inner surface of the gasket accommodating portion 22d) on one side X1 in the axial direction X in the bus bar cooling chamber 25a described below provided to orthogonally intersect with the cooling flow path 25 described below along the axial direction X.

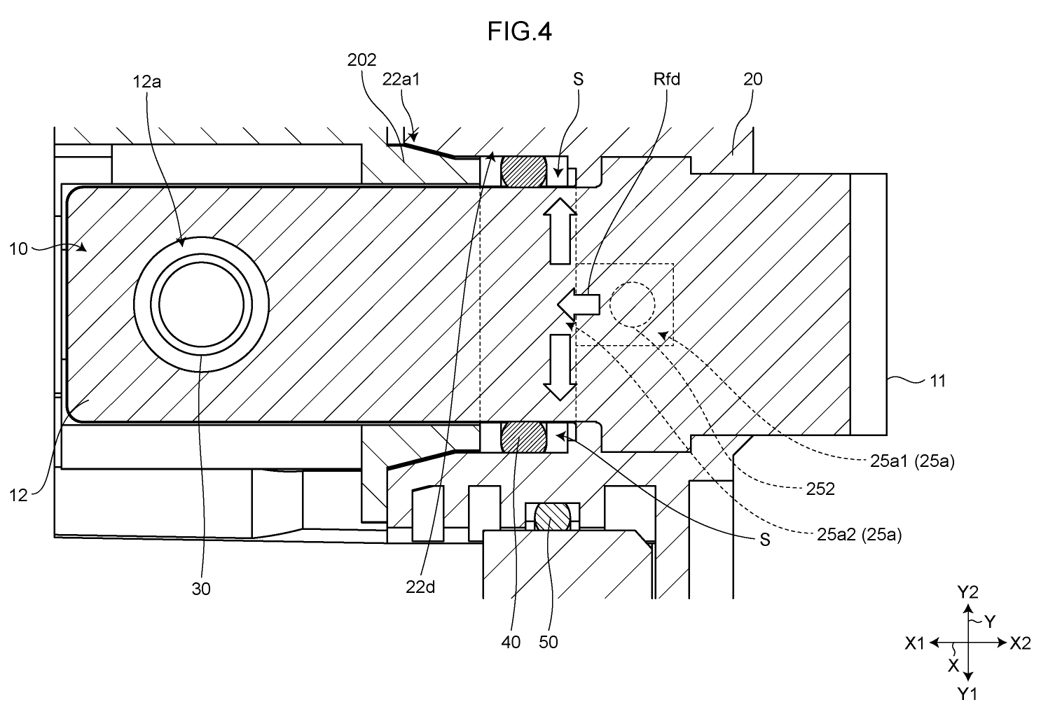

Also, as illustrated in FIGS. 3 and 4, the base portion 22a of the housing 20 is provided with the plurality of cooling flow paths 25 through which the cooling oil Rf flows corresponding to the respective bus bars 10. The cooling flow path 25 extends in an extending direction T along the height direction Z from a surface 20e1 on one side Z1 to a surface 20e2 on the other side Z2 in the height direction Z in the housing 20. That is, the cooling flow path 25 is a through hole linearly penetrating the housing 20 along the height direction Z. Also, the cooling flow path 25 is orthogonal to and intersects with the axial direction X in which the bus bar 10 extends. The bus bar cooling chamber 25a communicating with the cooling flow path 25 is provided in a part where the cooling flow path 25 and the second connection portion 12 (the inner portion 120) of the bus bar 10 intersect. The bus bar cooling chamber 25a is a space formed around the inner portion 120 of the bus bar 10. In other words, a part of the inner portion 120 of the bus bar 10 is disposed in the bus bar cooling chamber 25a.

The bus bar cooling chamber 25a includes a flow path connection portion 25a1 and a sealed portion 25a2 that communicates with the flow path connection portion 25a1 and is a space on the other side X2 in the axial direction X with respect to the gasket 40 stored in the gasket accommodating portion 22d. The flow path connection portion 25a1 is connected to a circular first cooling flow path 251 that is the cooling flow path 25 from the surface 20e1 on one side Z1 in the height direction Z of the housing 20 to the bus bar cooling chamber 25a and a circular second cooling flow path 252 that is the cooling flow path 25 from the bus bar cooling chamber 25a to the surface 20e2 on the other side Z2. The flow path connection portion 25a1 is formed to be larger than the circular first cooling flow path 251 and the circular second cooling flow path 252 in the axial direction X and the width direction Y and is formed to be larger than the plate thickness of the bus bar 10 in the height direction Z. The dimension of the flow path connection portion 25a1 in the width direction Y is sufficiently smaller than the dimension of the bus bar 10 (the inner portion 120) in the width direction Y. Therefore, the flow path connection portion 25a1 is partitioned into the first cooling flow path 251 side and the second cooling flow path 252 side by the inner portion 120 of the bus bar 10.

The one side X1 of the flow path connection portion 25a1 in the axial direction X communicates with the sealed portion 25a2. The sealed portion 25a2 is formed to have a larger dimension in the width direction Y than the flow path connection portion 25a1 and the inner portion 120 of the bus bar 10. The sealed portion 25a2 is formed to be larger than the plate thickness of the bus bar 10 and the flow path connection portion 25a1 in the height direction Z. The sealed portion 25a2 is partitioned with the first cooling flow path 251 side and the second cooling flow path 252 side by the inner portion 120 of the bus bar 10. However, as illustrated in FIG. 4, a gap S formed by the gasket 40, the side edge of the bus bar 10, and the housing 20 (the inner surface of the gasket accommodating portion 22d) allows the communication between the first cooling flow path 251 side and the second cooling flow path 252 side of the sealed portion 25a2.

Note that the holding portion 21c on the other side X2 in the axial direction X with respect to the flow path connection portion 25a1 of the bus bar cooling chamber 25a in the cooling flow path 25 is in close contact with the outer surface of the inner portion 120 of the bus bar 10 by the insert molding and thus is not sealed.

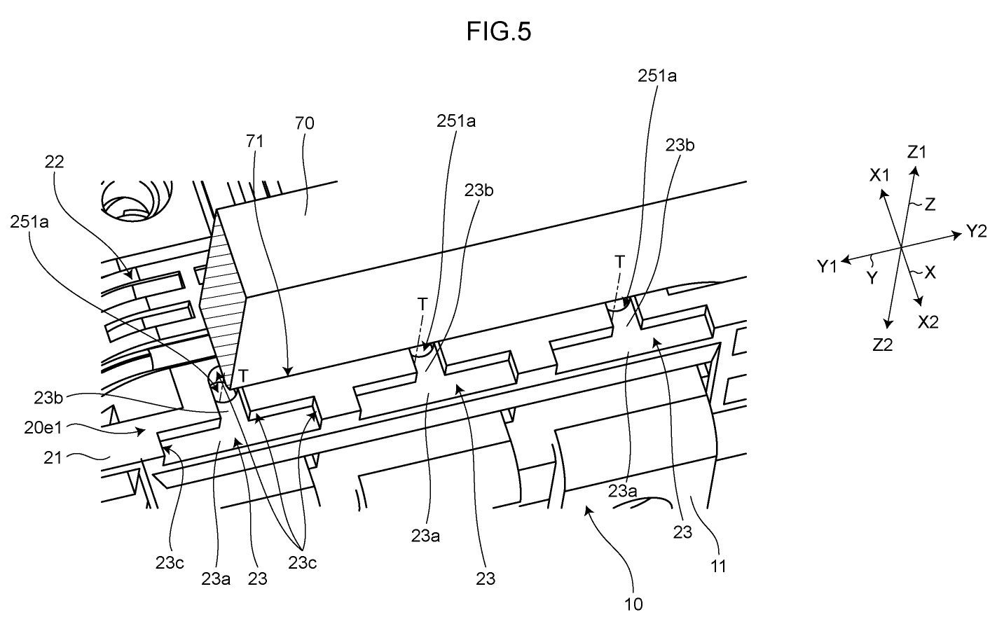

As illustrated in FIG. 5, an inlet 251a into which the cooling oil Rf flows is provided on one side (the one side Z1 in the height direction Z) in the extending direction T of the first cooling flow path 251 of the cooling flow path 25. The inlet 251a is provided in a storage groove portion 23 provided on the surface 20e1 on the one side Z1 in the height direction Z of the housing 20. The storage groove portion 23 includes a lateral groove portion 23a extending in the width direction Y and a longitudinal groove portion 23b extending from the lateral groove portion 23a toward the one side X1 in the axial direction X. The storage groove portion 23 (the lateral groove portion 23a and the longitudinal groove portion 23b) is formed in a recessed groove shape. The inlet 251a is disposed in the bottom portion of the end portion of the one side X1 of the longitudinal groove portion 23b in the axial direction X. In the lateral groove portion 23a, the side wall 23c is formed on the one side Y1 and the other side Y2 in the width direction Y and the one side X1 in the axial direction X, and the other side X2 in the axial direction X is opened. Also, the side wall 23c is also provided around the inlet 251a. Note that, on one side in the extending direction T (the one side Z1 in the height direction Z) of the inlet 251a, the inner peripheral surface of the attachment hole 71 of the attachment target 70 is disposed so as to cover the inlet 251a (see also FIG. 3).

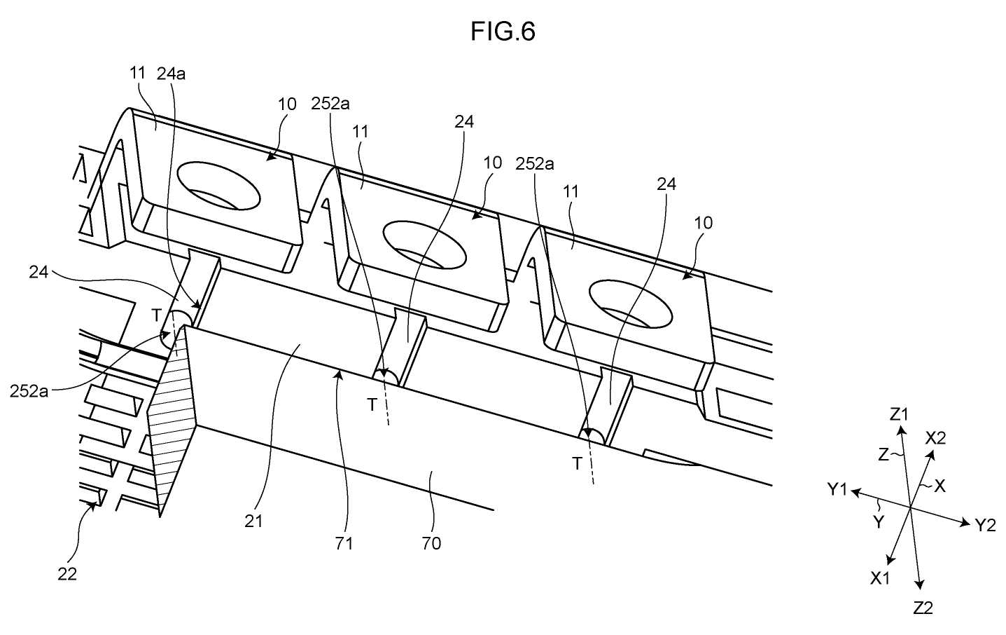

As illustrated in FIG. 6, on the other side in the extending direction T (the other side Z2 in the height direction Z) of the second cooling flow path 252 of the cooling flow path 25, an outlet 252a through which the cooling oil Rf flows out is provided. The outlet 252a is provided in a discharge groove portion 24 provided in the surface 20e2 on the other side Z2 in the height direction Z of the housing 20. The discharge groove portion 24 is a recessed groove extending on the one side X1 in the axial direction X. The outlet 252a is provided on the one side X1 in the axial direction X of the discharge groove portion 24. The outlet 252a is provided in the bottom portion of the discharge groove portion 24. In the discharge groove portion 24, a side wall 24a is formed, including the periphery of the outlet 252a, but the other side X2 in the axial direction X of the discharge groove portion 24 is open. Note that, on the other side in the extending direction T (the other side Z2 in the height direction Z) of the outlet 252a, the inner peripheral surface of the attachment hole 71 of the attachment target 70 is disposed so as to cover the outlet 252a (see also FIG. 3).

As illustrated in FIG. 3, the cooling oil Rf in the oil tank 80 is sprayed or the like to the first connection portion 11 in order to cool the first connection portion 11 of the bus bar 10 exposed from the terminal block 1 into the oil tank 80 by an oil pump or the like (not illustrated). Then, as indicated by an arrow Rfd, the cooling oil Rf sprayed or the like to the first connection portion 11 flows into the first cooling flow path 251 of the cooling flow path 25 from the storage groove portion 23 provided on one side Z1 in the height direction Z of the housing 20 via the inlet 251a. The cooling oil Rf flowing into the first cooling flow path 251 flows into the flow path connection portion 25a1 on the first cooling flow path 251 side. The cooling oil Rf flowing into the flow path connection portion 25a1 on the first cooling flow path 251 side flows along the surface on the one side Z1 in the height direction Z of the inner portion 120 of the bus bar 10 and flows into the sealed portion 25a2 on the first cooling flow path 251 side. Then, as illustrated in FIG. 4, the cooling oil Rf flowing into the sealed portion 25a2 on the first cooling flow path 251 side flows into the sealed portion 25a2 on the second cooling flow path 252 side via the gap S. The cooling oil Rf flowing into the sealed portion 25a2 on the second cooling flow path 252 side flows into the second cooling flow path 252 via the flow path connection portion 25a1 on the second cooling flow path 252 side. Then, the cooling oil Rf flowing into the second cooling flow path 252 flows out from the outlet 252a.

The cooling oil Rf flows and circulates in the cooling flow path 25 while filling the bus bar cooling chamber 25a on the first cooling flow path 251 side and the bus bar cooling chamber 25a on the second cooling flow path 252 side communicating with each other through the gap S to some extent. Therefore, the inner portion 120 of the bus bar 10 provided in the bus bar cooling chamber 25a is cooled by the cooling oil Rf flowing into the bus bar cooling chamber 25a. Also, in the gasket 40, since the cooling oil Rf flows into the sealed portion 25a2 of the bus bar cooling chamber 25a and circulates, the gasket is always exposed to the cooling oil Rf during the circulation of the cooling oil Rf.

The cooling oil Rf flowing out from the outlet 252a flows out into the oil tank 80 via the discharge groove portion 24 or directly and is returned. In the oil tank 80, the amount of heat of the cooling oil Rf is dissipated by an oil cooler or the like (not illustrated). Then, the cooling oil Rf with heat dissipated is sprayed or the like to the terminal block 1 again to cool the bus bar 10 and the inner portion 120 of the bus bar 10.

The cooling flow path 25 is linearly provided along the extending direction T. Therefore, the cooling oil Rf can smoothly flow from the inlet 251a toward the outlet 252a by the weight of the cooling oil Rf. Here, the inlet 251a is disposed in the longitudinal groove portion 23b of the storage groove portion 23, and the outlet 252a is disposed in the discharge groove portion 24. As a result, even at a position (that is, a position outside the oil tank 80) on one side X1 in the axial direction X with respect to the oil tank 80, for example, a position overlapping the inner peripheral surface of the attachment hole 71 of the attachment target 70 as in the present embodiment, the cooling flow path 25 formed linearly along the extending direction T can be disposed. Therefore, since the cooling flow path 25 can be appropriately disposed in the inner portion 120 at a position slightly farther from the one side X1 in the axial direction X than the first connection portion 11 of the bus bar 10 exposed in the oil tank 80, the degree of freedom in design is increased, and the entire bus bar 10 can be efficiently cooled.

Also, the longitudinal groove portion 23b of the storage groove portion 23 is connected to the lateral groove portion 23a. As a result, since the cooling oil Rf can be stored in the lateral groove portion 23a, the cooling oil Rf can be caused to continuously flow into the cooling flow path 25.

The terminal block 1 described above includes the bus bar 10 that extends in the axial direction X and is connected to the external terminal, and the housing 20 that holds the bus bar 10. The bus bar 10 has the inner portion 120 provided inside the housing 20. The cooling flow path 25 through which the cooling oil Rf as a cooling medium flows is provided inside the housing 20. The inner portion 120 of the bus bar 10 is provided in the cooling flow path 25.

As a result, the cooling oil Rf can be circulated inside the housing 20, and the inner portion 120 of the bus bar 10 provided in the cooling flow path 25 can be cooled by the cooling oil Rf. Therefore, not only the first connection portion 11 of the bus bar 10 exposed in the oil tank 80 but also the inner portion 120 of the bus bar 10 provided inside the housing 20 can be cooled by the cooling oil Rf, so that the area where the bus bar 10 and the cooling oil Rf are in contact with each other is increased and the cooling efficiency is improved, and the cooling of the bus bar 10 held by the housing 20 can be appropriately realized. In addition, since the cooling flow paths 25 are provided corresponding to the bus bars 10, it is easy to cope with an increase or decrease in the number of the bus bars 10. Furthermore, the cooling flow path 25 formed as a through hole reduces the amount of resin used for molding the housing 20, and it is possible to reduce the weight of the housing 20 and suppress the material cost.

Between the inner portion 120 of the bus bar 10 and the housing 20, the gasket 40 that is disposed around the axial direction X of the bus bar 10 and seals between the inner portion 120 and the housing 20 with respect to the cooling flow path 25 is provided. Here, the compression set of the rubber product is less likely to be set in a wet environment than in a dry environment. Therefore, according to the terminal block 1 of the present embodiment, the gasket 40 is constantly exposed to the cooling oil Rf during the circulation of the cooling oil Rf, so that the compression set rate of the gasket 40 can be reduced. Therefore, the sealing performance of the gasket 40 can be improved. In addition, since the set value of the initial compression ratio at the time of assembling the gasket 40 to the housing 20 is lowered, the housing 20 can be reduced in size and cost, and furthermore, the insertion force of the gasket 40 in the assembly work is lowered, so that the workability of the assembly work can also be improved.

In addition, the cooling flow path 25 extends in the extending direction T orthogonal to and intersecting the axial direction X, and includes the inlet 251a that is provided on one side in the extending direction T (the one side Z1 in the height direction Z) and into which the cooling oil Rf flows, and the outlet 252a that is provided on the other side in the extending direction T (the other side Z2 in the height direction Z) and from which the cooling oil Rf flows out. As a result, the inlet 251a is provided on the upper side, the outlet 252a is provided on the lower side, and the cooling flow path 25 is linearly formed along the extending direction T, and the cooling oil Rf flowing into the cooling flow path 25 can be caused to flow out by its own weight without providing a device such as a circulation pump.

Also, the inlet 251a is provided in the longitudinal groove portion 23b of the storage groove portion 23 including the lateral groove portion 23a extending in the width direction Y and the longitudinal groove portion 23b extending in the axial direction X from the lateral groove portion 23a. As a result, for example, the inlet 251a can be set corresponding to the inner portion 120 at a position farther from the one side X1 in the axial direction X than the first connection portion 11 of the bus bar 10 exposed in the oil tank 80, so that the entire bus bar 10 can be more efficiently cooled.

Note that the terminal block according to the embodiment of the present invention described above is not limited to the embodiment described above, and various modifications can be made within the scope described in the claims.

In the above description, as the attachment target 70 to which the terminal block 1 is attached, a part of the oil tank 80 is used, but the attachment target 70 may be another device in a case of a system that can cause the cooling oil Rf to flow into the cooling flow path 25 of the housing 20 and recover the flowing cooling oil Rf. Also, in the present embodiment, as the cooling medium, the cooling oil Rf is used, but another cooling medium such as cooling water may be used. Also, the cooling flow path 25 is not limited to a linear shape and may be provided by bending or the like.

The terminal block according to the present embodiment may be configured by appropriately combining the components of the embodiment and the modifications described above.

The terminal block according to the present embodiment has an effect of being capable of appropriately cooling the bus bar held by the terminal block.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a bus bar that extends in an axial direction and is connected to an external terminal; and
a housing that holds the bus bar, wherein
the bus bar has an inner portion provided inside the housing,
a cooling flow path through which a cooling medium flows is provided inside the housing, and
the inner portion of the bus bar is provided in the cooling flow path.

2. The terminal block according to claim 1, wherein
a gasket is provided between the inner portion of the bus bar and the housing, is disposed around the axial direction of the bus bar, and seals between the inner portion of the bus bar and the housing with respect to the cooling flow path.

3. The terminal block according to claim 1, wherein
the cooling flow path extends in an extending direction intersecting the axial direction, and includes an inlet that is provided on one side in the extending direction and into which the cooling medium flows, and an outlet that is provided on the other side in the extending direction and from which the cooling medium flows out.

4. The terminal block according to claim 2, wherein
the cooling flow path extends in an extending direction intersecting the axial direction, and includes an inlet that is provided on one side in the extending direction and into which the cooling medium flows, and an outlet that is provided on the other side in the extending direction and from which the cooling medium flows out.

5. The terminal block according to claim 3, wherein
the inlet is provided in a longitudinal groove portion in a storage groove portion, the storage groove portion including a lateral groove portion extending in a width direction intersecting the axial direction and the extending direction, and the longitudinal groove portion extending in the axial direction from the lateral groove portion.

6. The terminal block according to claim 4, wherein
the inlet is provided in a longitudinal groove portion in a storage groove portion, the storage groove portion including a lateral groove portion extending in a width direction intersecting the axial direction and the extending direction, and the longitudinal groove portion extending in the axial direction from the lateral groove portion.
